(19) United States
(12) Patent Application Publication
(10) Pub. No.: US 2011/0028169 A1
(43) Pub. Date: Feb. 3, 2011

(54) METHOD FOR OPERATING A COMMUNICATION TERMINAL

(75) Inventors: Stefan Baumann, Muenchen (DE); Jakob Sigg, Hohenkirchen (DE)

Correspondence Address: K&L Gates LLP, P.O. Box 1135, CHICAGO, IL, 60690, US

(73) Assignee: PALM, INC., Sunnyvale, CA (US)

(21) Appl. No.: 12/096,549

(22) PCT Filed: Nov. 27, 2006
(86) PCT No.: PCT/EP2006/068958

§ 371 Date: Feb. 17, 2009

(30) Foreign Application Priority Data
Dec. 8, 2005 (DE) 10 2005 058 669.4

(51) Int. Cl. H04B 15/00

(52) U.S. Cl. 455/501

(57) ABSTRACT

The invention discloses a method for operating a communication terminal comprising a receiver chain (EK) with at least one receiver component (RXD) and with an amplifier device (LNA) connected upstream thereof for receiving broadcast radio signals transmitted in first time periods in a predetermined frequency band, and also a transmission device (SEM) for transmitting radio signals. The method has the following steps. First of all, the noise occurring upon transmission of the radio signals in the frequency band of the receiver chain is measured in the receiver chain and then the gain of the amplifier device is set on the basis of the measured noise such that a maximum signal level on the receiver component is not exceeded. Measurement of the noise occurring by the transmission device thus allows the receiver chain to be protected by setting the amplifier device such that the signal level caused by the noise, in particular, is not exceeded, but the maximum possible sensitivity of the receiver chain for receiving radio signals can be set.

The present invention relates to a method for operating a communication terminal as well as a communication terminal itself, which is able to receive broadcast radio signals, such as digital television, and, furthermore, is able to transmit its own radio signals.

In this day and age communication terminals, such as mobile telephones, are no longer used just for telephoning, but rather are provided with a plurality of other technical applications owing to the miniaturization of electronic components. For example, modern mobile telephones have not only a radio module for communicating with a mobile radio network, such as in accordance with the GSM (global system for mobile communications) standard, but also an additional radio module for receiving digital television. Such a radio module (receiving module) for digital television can operate, for example, in accordance with the DVB-H (digital video broadcasting hand-held) standard.

Two VHF (very high frequency) bands (VHF 1: 46 MHz-68 MHz and VHF 3: 174 MHz-230 MHz) and the UHF (ultra high frequency) band (470 MHz-862 MHz) are suitable as the frequency range for the mobile digital television, according to the DVB-H standard. At the beginning of the introduction of digital television, in particular the UHF band will be used, according to the standardization committees, for DVB-H, whereas digital television, according to which the DVB-T (digital video broadcasting terrestrial) standard is emitted, will be used in the VHF bands.

For (mobile) communication terminals, like mobile telephones, which simultaneously receive DVB-H signals and are registered in a GSM network, the situation can now develop that the device emits GSM signals at a level up to +33 dBm in a frequency range of 890 MHz-910 MHz (and/or 880 MHz-915 MHz at E-GSM) and at the same time must be able to detect and/or pick up DVB-H signals up to a receiving level of −92 dBM at a frequency of 862 MHz. A visual illustration of the situation of the individual frequency ranges in relation to each other is shown in FIG. 8. In this case the frequency is plotted in MHz from left to right. In the frequency range depicted at the bottom, the DVB-H band is situated between 470 MHz and 862 MHz. Above this range in the example of the E-GSM is located the E-GSM uplink band between 880 MHz and 915 MHz, as well as the E-GSM downlink band between 925 MHz and 960 MHz.

The problem with mobile communication terminals, like mobile telephones, is the fact that the antenna for the. DVB-H radio module for receiving broadcast radio signals and/or digital television signals and the antenna for the GSM radio module with the transmission device for transmitting GSM radio signals exhibit a short spatial distance because of the usually small dimensions of mobile communication terminals; and in addition, the frequency distance between the DVB-H receiving band and the GSM (E-GSM) transmitting frequency band is short. Especially in an operating state of the communication terminal, in which both the DVB-H receiving module for receiving digital television signals is activated and the transmission device of the GSM radio module is activated, it is possible for the high transmission power emitted by the GSM radio module to cause a malfunction and in the worse case scenario the destruction of the DVB-H radio module, especially with respect to the input amplifier and/or the low noise amplifier. These malfunctions are caused, on the one hand, by a noise of the GSM transmission signal in the DVB-H receiving band and, furthermore, by a compression of the input amplifier and/or low noise amplifier in the DVB-H receiving module due to the too high GSM transmission signal.

In order to minimize now the malfunction of the DVB-H receiving module, stringent requirements must be placed on the suppression of noise. In this case it is possible to provide a band pass filter in the GSM transmission branch in order to reduce the transmission-sided noise. However, such a solution is expensive and, furthermore, requires a higher gain at the transmission-sided power amplifier, thus increasing the energy consumption of the GSM radio module and decreasing the service life of the communication terminal. Moreover, reducing the link between the GSM radio module and the DVB-H radio module by deploying special transmission-sided filters and/or by deploying special antenna designs is difficult because the constantly changing environment of a mobile communication terminal makes it difficult to predict each operating state (for example, when a mobile communication terminal, like a mobile telephone, is placed on the roof of a car, etc.), as result of which there is, nevertheless, a malfunction and/or destruction of the DVB-H receiving module.

Therefore, the object of the present invention is to provide a simple possibility for operating a communication terminal. According to the invention, the reception of a useful signal is optimized, and the risk of destruction during reception of the broadcast radio signals owing to a transmission device is minimized.

This object is achieved by the independent claims. Advantageous embodiments are the subject matter of the dependent claims.

In this case a method for operating a communication terminal, which comprises a receiver chain with at least one receiver component and with an amplifier device, connected upstream of said receiver component, for receiving broadcast radio signals, which are transmitted in first time periods, in a predetermined frequency band, as well as a transmission device for transmitting radio signals, comprises the following steps. First of all, the noise, occurring upon transmission of the radio signals in the frequency band of the receiver chain, is measured in a receiver chain. Then the gain of the amplifier device is set as a function of the measured noise in such a manner that a maximum signal level, applied to the receiver component, is not exceeded.

In this way, when the transmission device transmits radio signals, the influence of the noise on the receiver chain can be measured and/or detected and then can be set (low) as a function of the gain of the receiver chain in such a manner that a destruction of the receiver component is no longer possible. However, on the other hand, based on the measurement and/or detection of the noise in the receiver chain upon transmission of radio signals by means of the transmission device, the gain in the amplifier device can be set (high) in such a manner that an optimal reception of the useful signal is guaranteed. This means that owing to the described method it is possible to produce a compromise solution comprising the best possible reception of useful signals (in this case the broadcast radio signals) and the need for reliability in order to prevent the destruction of the receiver chain.

According to one advantageous embodiment, the measurement of the noise in the receiver chain is carried out in first intermediate time periods, which lie between the first time periods. This means that the measurement of the noise takes place precisely when no broadcast radio signals are received or are to be received by the receiver chain. This has the advantage that a measurement of the noise does not adversely affect the receiving and/or the processing of useful signals and/or broadcast radio signals.

According to another advantageous embodiment, the transmission device transmits the radio signals in second—in particular, repeating—time periods, which overlap at least partially the first time periods. Therefore, it is possible that the transmission device operates in accordance with a mobile radio standard, such as in accordance with the GSM standard. According to this mobile radio standard, at specific times during the second time periods the radio signals are transmitted in so-called transmission bursts by the transmission device to a base station of a mobile radio network. Ultimately these transmission bursts may be the cause for a malfunction in the reception of broadcast radio signals in the receiver chain. However, it is also possible that the transmission device operates in accordance with the UMTS (universal mobile telecommunications system) standard, according to which, instead of transmitting radio signals in second time periods, a continuous transmission of radio signals takes place.

According to another advantageous embodiment, the measurement and/or detection of noise is carried out repeatedly. Therefore, it is possible to carry out the measurement of the noise at regular time intervals. In one embodiment, where the transmission device is able to vary the transmission frequency, at which it transmits radio signals, the measurement of the noise can then be carried out after the transmission device has changed the transmission frequency. The measurement takes place in an advantageous way in the first intermediate time periods, which lie between the first time periods. Furthermore, it is possible that the transmission device is able to vary the transmission power, with which it transmits the radio signals. Then the measurement of the noise is carried out after the transmission device has changed the transmission power. In this case, too, the measurement of the noise takes place in an advantageous way in the first intermediate time periods, after the transmission power has been changed. Furthermore, it is also possible that the receiver chain is able to vary the receiving frequency, at which a specific broadcast radio service and/or specific broadcast radio signals, allocated to said service, is/are received, within the frequency band. Then the measurement of the noise is carried out, after the receiver chain has changed the receiving frequency. In this case, too, the measurement takes place in an advantageous way in the first intermediate time periods, after the receiving frequency has been changed.

According to another advantageous embodiment, prior to conducting the measurement of the noise, the gain of the amplifier device is set to the maximum possible value, at which no destruction of the receiver component during the measurement occurs. This means that in order to avoid damaging the receiver component, the gain of the receiver device is set so insensitive for measuring the noise that damage to the subsequent receiver component and/or the receiver chain components that follow (at the maximum expected signal level and/or noise signal level) is prevented with certainty. After a measurement of the noise and/or the noise level in the receiver chain on the basis of a radio signal of the transmission device, the noise level, which is caused by the transmission device, is known so that the gain of the amplifier device can be set again, as above, in such a manner that, on the one hand, the useful signal level (of the broadcast radio signals), received by the receiver chain, is optimized, whereas at the same time, however, a destruction of the receiver chain, in particular of the receiver component, by radio signals from the transmission device is prevented.

According to another advantageous embodiment for improving the reception of the useful signal, the receiver chain comprises additionally an adjustable band pass filter for passing a desired frequency band. Therefore, the band pass filter is adjusted in such a manner in relation to the frequency band, as a function of the measured noise, that the noise, caused due to the transmission of the radio signals, in the receiver chain is minimized. In this case the band pass filter should be adjusted in such a manner that at a maximum sensitivity for the reception of the broadcast radio signals the noise in the receiver chain is minimized.

According to another advantageous embodiment for improving the reception of useful signals and/or broadcast radio signals, the receiver chain has a tunable—in particular, narrow band—antenna for receiving a desired frequency band. In this case the antenna is adjusted in such a manner in relation to the frequency band as a function of the measured noise that the noise, caused by the transmission of the radio signals, in the receiver chain is minimized. In particular, the antenna is to be set in such a manner that at maximum sensitivity for the reception of broadcast radio signals, the noise, caused due to the transmission of the radio signals, in the receiver chain is minimized.

According to another advantageous embodiment, during the measurement of the noise the spectral properties of the noise are ascertained, the linearity of the amplifier device being set as a function of the determined spectral maxima, such as tracks, etc. In this way a distortion of the broadcast radio signals and/or the useful signals is achieved.

According to another advantageous embodiment, the transmission device comprises an insertable, transmission-sided band pass filter, which can be inserted—preferably downstream of a power amplifier for amplifying the transmission signals—, as a function of the measured noise, into the transmission path of the transmission device, so that the noise, caused due to the transmission of the radio signals, in the receiver chain is minimized. In this case the transmission device and/or the insertable band pass filter can be operated in such a manner that in conformity with the standard (when the receiver chain is not activated and/or does not receive any broadcast radio signals), the insertable band pass filter is not connected into the transmission path, whereas in the event of an activated receiver chain and in the event of a simultaneous measurement of a noise level beyond a maximum threshold value, the insertable band pass filter is connected into the transmission path of the transmission device, in order to minimize the noise level in the receiver chain. However, it is also possible to operate the transmission device in such a manner that in accordance with the standard (in the event of a deactivated receiver chain) the band pass filter is not connected into the transmission path of the transmission device, whereas on activation of the receiver chain for receiving broadcast radio signals, the insertable band pass filter is always simultaneously connected into the transmission branch of the transmission device (thus, independently of the measured noise level).

In this case the broadcast radio signals, which are received by the receiver chain, can comprise digital television signals or radio signals. In particular, the broadcast radio signals can comprise digital television signals in accordance with the DVB (digital video broadcasting) standard. In order to operate mobile communication terminals, which usually exhibit only one small or limited source of energy (accumulator), the use and/or reception of digital television signals in accordance with the DVB-H standard is/are advantageous. In this case the transfer of the DVB-H broadcast radio signals to the communication terminal takes place for a specific DVB-H service and/or a specific DVB-H program in the first time periods, which can exhibit a length between 20 milliseconds and several seconds. Therefore, the first time periods are then interrupted by transmission and/or reception breaks (intermediate time periods) lasting several seconds. However, it is also conceivable that the received broadcast radio signals comprise digital radio signals, for example, in accordance with DAB (DAB: digital audio broadcasting). Should it turn out upon measuring the noise and/or noise level that the malfunction or rather the noise level due to the radio signals transmitted by the transmission device is very much larger than the receiving level of the broadcast radio signals (on the one hand, the receiver chain measures the noise level in the first intermediate time periods of the noise caused by the radio signals of the transmission device, and, on the other hand, the receiver chain measures the signal level and/or the useful signal level in the first time periods on reception of the broadcast radio signals, advantageously when no radio signals are transmitted), the measurement results (of the noise signal level and the useful signal level) can be used to give the user of the communication terminal an acoustical and/or visual and/or mechanical (for example, by means of vibration) indication that the reception of broadcast radio signals in the following may be faulty and/or will terminate.

Furthermore, it is conceivable that on the basis of the measurement of the noise level on the grounds of the transmission of radio signals on the part of the transmission device with respect to the useful signal level the transmission power of the transmission device may be at least temporarily decreased (by one or more levels of performance), at least until a base station, which is connected to the communication terminal and/or the transmission device, demands (especially in the case of a mobile radio connection) of the transmission device more transmission power.

According to another aspect of the invention, a communication terminal is provided, in particular, for carrying out an above-described method and/or an embodiment thereof. Therefore, the communication terminal has a receiver chain, which comprises at least one receiver component and an amplifier device, which is connected upstream of said receiver component, for receiving broadcast radio signals, which are transmitted in first time periods, in a predetermined frequency band. Furthermore, the communication terminal has a transmission device for transmitting radio signals. In addition, it has a control unit, which is connected to the receiver chain and is configured to determine the noise, occurring upon transmission of the radio signals in the frequency band of the receiver chain, in the receiver chain, and to set the gain of the amplifier device as a function of the determined noise in such a manner that a maximum signal level, which is applied to the receiver component, is not exceeded. Therefore, it is especially possible to measure and/or determine, prior to the reception of the broadcast radio signals, the noise, occurring upon transmission of the radio signals by the transmission device, in the receiver chain. In this way the receiver chain and/or the amplifier device can be set in such a manner that no malfunction due to the transmission device occurs, but simultaneously the receiver chain and/or the amplifier device is/are set to the maximum sensitivity for the reception of broadcast radio signals.

According to an advantageous embodiment, the control unit is configured so as to carry out the determination of the noise in the receiver chain in first intermediate time periods, which lie between the first time periods. In particular, however, as stated above, the determination of the noise already takes place prior to the reception of the broadcast radio signal and/or prior to a first time period, so that the gain (and/or the sensitivity) of the receiver chain is already set so as to be optimal for the reception of broadcast radio signals without risking any damage to the receiver chain.

According to another advantageous embodiment, the transmission device is configured so as to transmit the radio signals in second time periods. In this case it is possible that the second time periods overlap at least partially the first time periods. Depending on the respective radio standards, according to which the transmission device operates, it is also possible that the second time periods periodically succeed each other and are interrupted by second intermediate time periods. Especially when the transmission device operates in accordance with the GSM standard, the radio signals are transmitted in bursts to a corresponding mobile radio base station during the second time periods.

According to another advantageous embodiment, the control unit is configured so as to carry out repeatedly the detection of noise in the receiver chain. In this case the detection of noise can be carried out at regular time intervals. However, it can also be carried out as a function of certain transmission parameters. For example, when the transmission device is able to vary its transmission frequency, at which it transmits the radio signals, the control unit can then carry out the detection of noise, after the transmission device has changed the transmission frequency. Correspondingly it is possible that the transmission device varies its transmission power, so that the control unit carries out the detection of noise, after the transmission device has changed its transmission power. However, the detection of noise can also be carried out as a function of the receiving parameters. Therefore, it is possible that the receiver chain is able to vary its receiving frequency, at which a specific broadcast radio service and/or its allocated broadcast radio signals is/are received, within the frequency band. Then the control unit carries out the detection of the noise, after the receiver chain has changed the receiving frequency.

According to another advantageous embodiment, the control unit is configured so as to set, prior to carrying out the detection of the noise, the gain of the amplifier device to a maximum possible value, at which no destruction of the receiver component occurs during the measurement. In other words, the amplifier device is set to such an insensitive (maximally still possible) value, at which a destruction of the receiver component can be ruled out. After the measurement, the gain can then be adjusted correspondingly in such a manner that when the receiver chain and the transmission device are operated simultaneously, the maximum sensitivity for the reception of broadcast radio signals is set without risking the destruction of the receiver chain due to the noise caused upon the transmission of radio signals.

According to another advantageous embodiment, the receiver chain has, furthermore, an adjustable band pass filter for passing a desired frequency band. In this case the control unit adjusts the band pass filter in relation to the frequency band as a function of the measured noise in such a manner that the noise, caused by the transmission of the radio signals, in the receiver chain is minimized. Furthermore, the receiver chain can exhibit a tunable (narrow band) antenna for receiving a desired frequency band. In this case the control unit sets the antenna in relation to the frequency band as a function of the measured noise in such a manner that the noise, caused by the transmission of the radio signals, in the receiver chain is minimized. Moreover, it is possible that, furthermore, the spectral properties of the noise are determined upon detection of the noise. Then the control unit adjusts the linearity of the amplifier, device as a function of the determined spectral maxima, such as tracks. Furthermore, the transmission device can exhibit an insertable transmission-sided band pass filter. In this case the control unit connects the transmission-sided band pass filter as a function of the measured noise into the transmission path of the transmission device, preferably connected downstream of a power amplifier for amplifying the transmission signals, so that the noise, caused by the transmission of the radio signals, in the receiver chain is minimized.

In this case the communication terminal can be designed as a portable device, in particular as a mobile radio device, a mobile telephone or as a portable computer with a radio module.

Preferred embodiments of the present invention are explained in detail below with reference to the attached drawings.

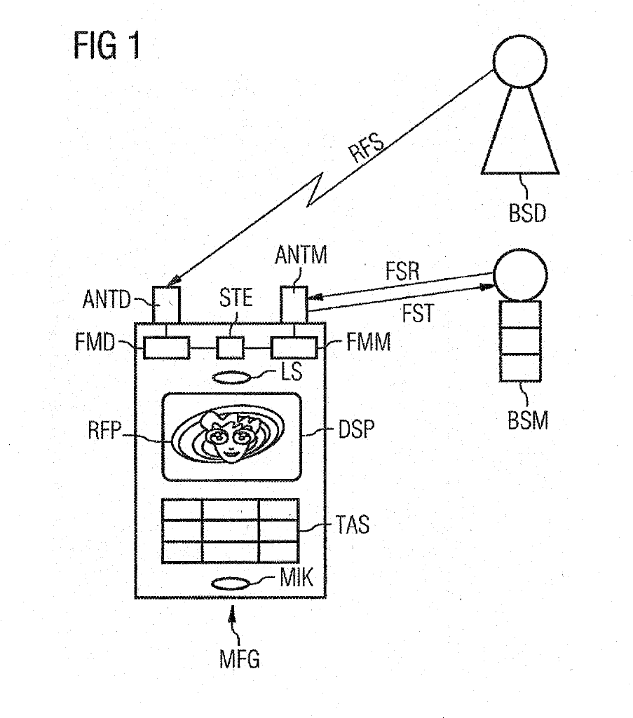

FIG. 1 is a schematic rendering of a mobile telephone as a communication terminal in a telecommunications system, wherein the mobile telephone is connected to a broadcast radio station as well as to a mobile radio base station.

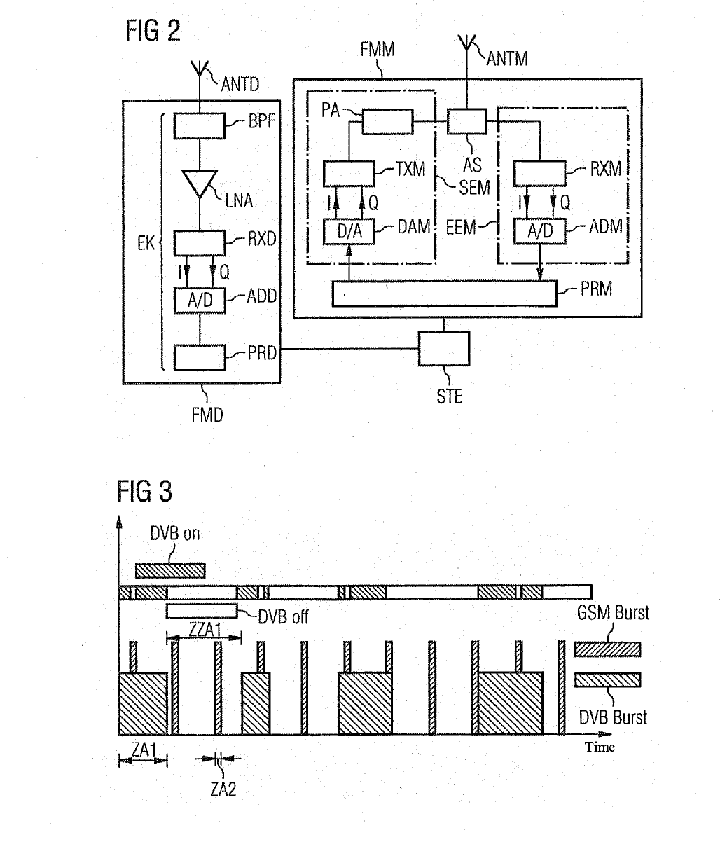

FIG. 2 is a simplified schematic rendering of a receiver chain for receiving broadcast radio signals as well as a transmission/receiving device for transmitting and receiving mobile radio signals.

FIG. 3 depicts a time structure for illustrating first time periods, in which broadcast radio signals are received in accordance with the DVB-H standard, and for illustrating second time periods, in which mobile radio signals are transmitted in accordance with the GSM standard.

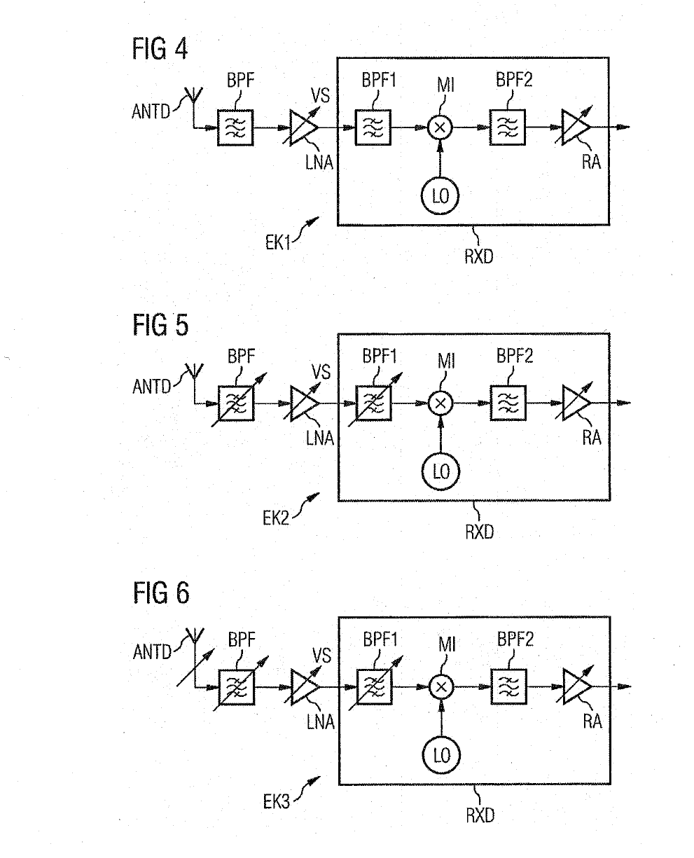

FIG. 4 depicts a first preferred embodiment of a receiver chain for improving the reception of broadcast radio signals.

FIG. 5 depicts a second preferred embodiment of a receiver chain for improving the reception of broadcast radio signals.

FIG. 6 depicts a third preferred embodiment of a receiver chain for improving the reception of broadcast radio signals.

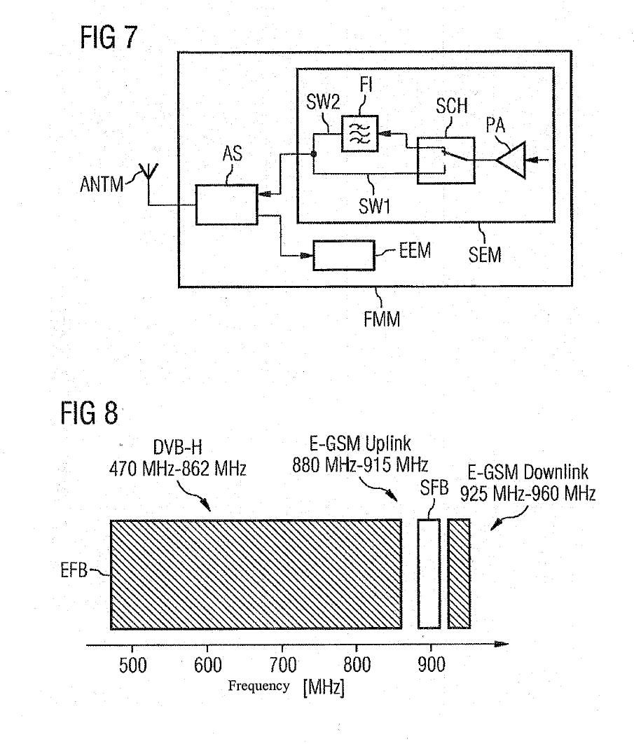

FIG. 7 depicts a preferred embodiment of a transmission device for improving the reception of broadcast radio signals in a receiver chain, which is disposed with the transmission device in a communication terminal.

FIG. 8 is a schematic rendering of the frequency bands that are used in accordance with the

DVB-H standard and the E-GSM (extended global system for mobile communication) standard.

The first reference is made to FIG. 1, which shows a telecommunications system. In this case the telecommunications system comprises a broadcast radio station or rather a broadcast radio base station BSD for emitting broadcast radio signals RFS in the form of digital television signals in accordance with the DVB-H standard. Furthermore, the telecommunications system comprises a base station BSM of a mobile radio network, which operates, according to the embodiment, in accordance with the GSM and/or E-GSM standard. In this case the base station BSM is able to set up a radio link with mobile communication terminals, like mobile telephones, and, in addition, to transmit radio signals FSR to a respective communication terminal or rather a mobile telephone and to receive radio signals FST from the respective communication terminal or rather mobile telephone.

Finally the telecommunications system comprises a communication terminal in the form of a mobile telephone MFG. This mobile telephone MFG has a loudspeaker LS for outputting acoustical signals, like sounds, speech or noises, and has correspondingly a microphone MIK for picking up the acoustical signals. Moreover, the mobile telephone MFG has a keypad TAS for inputting the control instructions or rather the graphic symbols. In order to be able to receive the broadcast radio signals RFS of the base station BSD and, thus, the digital television, the mobile telephone MFG has an antenna ANTD, which is connected to a radio module FMD. The radio module FMD comprises a receiver chain (as shown in detail in FIG. 2), which is able to process the broadcast radio signals RFS and to forward the processed (digitized) signals to a display device DSP, so that the display device can show the useful data, contained in the broadcast radio signals RFS, in the form of a television picture. According to the embodiment, the display DSP is currently showing a received television program RFP, represented by the head in the middle of the display.

In order to communicate with the base station BSM of the mobile radio network, the mobile telephone MFG has, furthermore, an antenna ANTM, which is able to transmit radio signals FST to the base station BSM and to receive radio signals FSR from the base station BSM. Therefore, the antenna ANTM is connected to a radio module FMM, which is able to generate and also to receive and process radio signals in accordance with the GSM standard.

Finally the mobile telephone MFG also comprises a control unit STE, which is connected to both the radio module FMM and to the radio module FMD. From the radio module FMM the control unit receives the transmission parameters, such as the time structure of the transmission of radio signals FST, the transmission power, with which the radio signals FST are emitted, as well as the transmission frequency or rather the transmission frequency band, at which the radio signals FST are emitted. From the radio module FMD the control unit receives the receiving parameters, such as the time structure of the reception of broadcast radio signals RFS, the signal field strength, with which the broadcast radio signals RFS are received, as well as the receiving frequency or rather the receiving frequency band, in which the broadcast radio signals are received. As explained below with respect to the FIGS. 4 to 7, the control unit STE is able, on the basis of the measurement and/or detection of the noise in the receiver chain due to the transmission of radio signals on the part of the transmission device, to activate the radio module FMD or rather the receiver chain, contained in said radio module, in such a manner that an optimization of the reception of broadcast radio signals in the receiver chain is achieved while at the same time the risk of destruction is minimized.

At this stage reference is made to FIG. 2, which shows in detail a schematic drawing of a radio segment of the mobile telephone, comprising the radio modules FMM and FMD, as well as the control unit STE. Starting from the antenna ANTD, a receiver chain, which is provided in the radio module FMD, or rather the receiving chain EK of the radio module FMD, comprises, first of all, a band pass filter BPF for passing a specific receiving frequency band. Then a broadcast radio signal, filtered by means of the band pass filter BPF impinges on a low noise amplifier LNA for amplifying the filtered broadcast radio signal. Then this amplified (analog) broadcast radio signal is fed to the receiver component or rather the receiving component RXD for further processing (more gain, filtering, demodulation, etc.). Then the components I and Q, obtained from the demodulation, (in phase signal content and quadrature signal content within the framework of an I/Q modulation) are fed to an analog-digital converter ADD, which then converts the fed in analog signals into digital signals. Then these digital signals are fed to a processor PRD, which then performs the conditioning of the signals in the base band. The aforementioned receiving parameters are obtained by the control unit, for example, from the processor device PRD. It must be pointed out that the signal field strength, with which the broadcast radio signals RFS are received by the radio module FMD or rather the receiver chain EK, was referred to above as the receiving parameters. This means that the receiver chain is able to measure and/or determine the signal field strength of signals that appear within the receiving frequency band. Thus, the receiver chain is also able to measure and/or detect the noise that is perceived in the receiver chain EK upon transmission of radio signals by means of the transmission device SEM. Besides the noise level it is also possible to analyze with the receiver chain the spectral properties of the noise. Thus, the noise parameters (level, spectrum), measured by the receiver chain, can be transferred, for example, from the processor device PRD to the control unit STE, so that the control unit STE can set the radio module FMM and/or the radio module FMD as a function of the recorded noise parameters so as to achieve an optimal reception of the broadcast signals by means of the radio module FMD.

Starting from the antenna ANTM, the radio module FMM comprises an antenna switch AS, which is connected to both a transmission device SEM and to a receiving device EEM of the radio module FMM. In the simplified drawing the receiving device EEM comprises a receiver component or rather a receiving component RXM for processing the received radio signals FSR (for filtering, amplifying, demodulating, etc.). Then the analog signal contents I and Q of the processed radio signals FSR are fed to an analog-digital converter ADM, which converts the analog signals into digital signals and then feeds these digital signals to a processor device PRM, which then processes the signals in the base band. Starting from the processor device PRM, the digital signals, which are to be transmitted to the base station BSM, are fed to the transmission device SEM. Then they are converted into analog signals and/or into signal contents I and Q by a digital-analog converter DAM in said transmission device. Then said signals are fed to a transmission component TXM. The signals are modulated in the transmission component TXM and then fed to a power amplifier PA, so that they can be transmitted as radio signals FST with suitable power to the base station BSM by means of the antenna switch AS and the antenna ANTM.

At this stage reference is made to FIG. 3, which shows a time structure of broadcast radio signals (DVB-H bursts; low broad bursts) emitted by the broadcast radio station BSD as well as the radio signals FST (GSM bursts; high narrow bursts) transmitted by the mobile telephone. In this case the DVB-H bursts occur in first time periods ZA1. Their duration for the first of four first time periods is illustrated in the figure. The duration of the time periods ZA1 can vary in length. Between the first time periods ZA1 there are first intermediate time periods ZZA1, in which no DVB-H bursts occur. As explained in detail below, a measurement of the noise, which is caused due to the transmission of radio signals by the transmission device SEM, takes place preferably in the first intermediate time periods ZZA1. In this case it must be pointed out that not only the first time periods ZA1, but also the first intermediate time periods ZZA1 between the individual DVB-H bursts may vary in length. A DVB-H burst indicates when the next DVB-H burst can be expected again. In this case it must be pointed out that the DVB-H burst is a burst of a specific DVB-H service, which is transferred, according to the DVB-H standard, in individual time periods or rather time slots.

Furthermore, FIG. 3 shows the GSM bursts, which always occur with a constant length and at a uniform distance from the next burst in the second time periods ZA2. Furthermore, it is clear from the figure that owing to the varying durations of the first time periods ZA1 and the varying long breaks between the DVB-H bursts (first intermediate time periods of varying length), the result is an at least partial overlapping of the DVB-H bursts and the GSM bursts. It is precisely during this overlapping that the destruction occurs upon receiving the broadcast radio signals RFS.

At this stage the following FIGS. 4 to 7 shall illustrate the circuit-related possibilities of how to optimize the reception of broadcast radio signals and/or how to avoid the destruction of the receiver chain EK of the radio module FMD.

Reference shall be made first to FIG. 4, which shows a first preferred embodiment of the invention for improving the reception of broadcast radio signals and for preventing the destruction of the receiver chain and/or the components thereof. In more precise terms, FIG. 4 depicts a detail of a receiver chain, which can be used in the radio module FMD, shown in FIG. 2, for receiving and processing broadcast radio signals. In this case the receiver chain EK1, shown in FIG. 4, corresponds in essence to the receiver chain EK or rather the corresponding detail thereof in FIG. 2. Thus, the receiver chain EK1 has an antenna ANTD for receiving broadcast radio signals, in particular digital broadcast radio signals, like television signals, in accordance with the DVB-H standard. Then the received broadcast radio signals run into a band pass filter BPF and from there into an input amplifier or rather a low noise amplifier LNA. Then a signal, amplified by means of the amplifier LNA, is fed to a receiver component RXD. As shown in the example in the present case, the receiver component RXD comprises a first band pass filter BPF1 for passing a specific frequency band, a downstream connected mixer MI, which is connected to a local oscillator LO, as well as a downstream connected second band pass filter BPF2 for passing a. second frequency band, and finally a second amplifier RA for amplifying a signal, which has passed through the second band pass filter BPF2. Then a signal, which has passed through the receiver component RXD, can be fed, as shown in FIG. 2 with respect to the receiver chain EK, (split into signal contents I and Q) to an analog-digital converter ADD and/or from there to a processor PRD.

One characteristic feature of the receiver chain EK1 is that the power and/or the gain VS of the low noise amplifier LNA can be adjusted by means of the control unit STE. In addition, the gain of the amplifier RA can also be adjusted, according to the example, in FIG. 4.

At this point the operating mode of the circuit, shown in FIG. 4, for optimizing the reception of the broadcast radio signals shall be explained below. Therefore, reference must be made to FIG. 3, which illustrates, as stated above, the time structure of the broadcast radio signals emitted by the broadcast radio station BSD in the first time periods ZA1 as well as the radio signals FST transmitted by the transmission device SEM of the mobile telephone MFG. In order to be able to achieve at this point the highest possible sensitivity for receiving broadcast radio signals, without risking the destruction of the receiver chain EK1, it is advantageous to measure, for example, before the first first time period ZA1, a measurement of the noise, perceived by the receiver chain EK1 due to the transmission of radio signals on the part of the transmission device SEM. A measurement of the noise in the first intermediate time periods ZZA1 is also possible. In the periods, like the first intermediate time periods, the radio module FMD should not receive any broadcast radio signals, so that it is advantageous for the measurement of the noise on the part of the transmission device to set the gain VS to a (maximum possible) value, at which hardly any destruction of the receiver component RXD is possible. It must be pointed out that it is not advantageous to set the gain too low, since otherwise the measurement of the aforementioned noise parameters could be inadequately good. After the gain VS of the amplifier LNA has been set “insensitive,” a GSM burst during a second time period ZA2 is now generated by the transmission device SEM. In parallel thereto, the noise, generated by the GSM burst, is measured and/or detected in the receiver chain EK1. In particular, the level of the noise caused by the GSM burst is determined (for the circuit in FIG. 4). As stated above, the noise level can be forwarded to the control unit STE by a processor PRD, which is connected downstream of the receiver component RXD, shown in FIG. 4. At this point the control unit STE can activate the amplifier LNA as a function of the measured and/or detected noise level in such a manner that the gain VS of the amplifier is set to a value, which offers maximum sensitivity for receiving broadcast radio signals, but does not exceed a maximum signal level, which may be applied to the receiver component RXD without destroying it. Correspondingly the gain of the amplifier RA can also be set for improving the reception and/or for decreasing the faults upon reception of broadcast radio signals.

It is advantageous to repeat the above described measurement of the noise once or multiple times or even at regular time intervals, however especially when changing the transmission frequency of the transmission device and/or a receiving frequency of the receiver chain for receiving broadcast radio signals, or also upon changing the transmission power of the transmission device. In this case the fault caused by the noise of the transmission device can be determined by means of one measured GSM burst or a plurality of measured GSM bursts.

At this point reference is made to FIG. 5, which shows a second embodiment for improving the reception of broadcast radio signals. In this case the receiver chain EK2, shown in FIG. 5, corresponds in essence to the receiver chain EK1, shown in FIG. 4, for which reason reference is made to FIG. 4 or to FIG. 2 for a detailed explanation.

One characteristic feature of the second embodiment is that there are not only the amplifiers LNA and RA, the gain VS of which can be set, but also band pass filters BPF and BPF1, the receiving frequency band of which can be changed. In accordance with the method, shown in FIG. 4, for optimizing the adjustments of the receiver chain for receiving broadcast radio signals, a measurement of the noise, caused due to the transmission device SEM, is measured and/or determined, before the reception of a broadcast radio signal and/or in the first intermediate time periods ZZA1. As stated above with respect to FIG. 4, it is advantageous to determine not only the noise level, but also the spectral properties of the noise. For this reason, at a time at which no broadcast radio signal is expected, the receiver chain and/or the low noise amplifier LNA or also the amplifier RA is/are switched so as to be insensitive, in order to avoid a destruction of the receiver chain and/or the components thereof. At this point the transmission device SEM generates a GSM transmission burst during a second time period ZA2. At this point the noise, perceived owing to this burst, is measured and/or determined by the receiver chain EK2. Now with the aid of the measured noise level the amplifiers LNA and/or RA can be set, as explained with respect to FIG. 4. Furthermore, with the aid of the measured noise spectrum the pass range of the filter BPF and/or the filter BPF1 can also be set now in such a manner that the influence of the noise on the part of the transmission device SEM on the reception of the broadcast radio signals by the receiver chain EK2 is minimized. If, for example, the noise spectrum exhibits spectral maxima, such as tracks, the filter BPF and/or the filter BPF1 can be set in such a manner that, for example, such spectral maxima are no longer passed through a respective filter. In this way the reception of the broadcast radio signals is improved; and a malfunction and/or destruction owing to the radio signals and/or the transmission bursts on the part of the transmission device SEM is/are minimized.

At this point reference is made to FIG. 6, which shows a third embodiment for optimizing the adjustments of the receiver chain for receiving broadcast radio signals. In this case the receiver chain EK3, shown in FIG. 6, corresponds in essence to the receiver chain EK2, shown in FIG. 5, for which reason reference is made to one of the preceding figures for a detailed explanation of the respective components that are presented.

The characteristic feature of the third embodiment, according to FIG. 6, is the fact that not only the adjustable filters and amplifiers but also the antenna setting of the antenna ANTD is variable. As explained with respect to FIG. 5, at a time, at which no broadcast radio signal is expected (before a first time period or in a respective first intermediate time period), the receiver chain and/or the low noise amplifier LNA or also the amplifier RA is/are switched so as to be insensitive, in order to avoid a destruction of the receiver chain and/or the components thereof. At this point the transmission device SEM generates a GSM transmission burst during a second time period ZA2. At this point the noise, perceived owing to this burst, is measured and/or determined by the receiver chain EK2. Now with the aid of the measured noise level the amplifiers LNA and/or RA can be set, as explained with respect to FIG. 4. Furthermore, the pass range of the filters BPF and BPF1 can also be set now, as explained with respect to. FIG. 5, by means of the measured noise level in such a manner that the influence of the noise on the part of the transmission device SEM on the reception of the broadcast radio signals by the receiver chain EK2 is minimized. As in the case of setting the receiving frequency band by means of one of the filters BPF and/or BPF1, according to FIG. 5, it is also possible here with respect to the third embodiment to vary the receiving range of the especially narrow band antenna ANTD. For example, the receiving range and/or the receiving frequency band of the tunable antenna can be set in such a manner that there is maximum sensitivity for the reception of broadcast radio signals, whereas there is minimal fault caused by a GSM burst. In particular, the receiving range of the tunable antenna ANTD can be selected in such a manner so as not to receive and/or so as to eliminate spectral maxima of noise. It must also be pointed out that the embodiment in FIG. 6 can be modified in such a manner that only the pass range of the antenna ANTD can be set, but not the band pass filters BPF and/or BPF1.

In order to achieve a suitable antenna setting it is also possible to conduct at the same time the measurements repeatedly. Then different antenna settings can be checked during a series of measurements, and that setting that involves the least fault in the receiver chain, is then chosen for the reception of the broadcast radio signals.

At this point reference is made to FIG. 7, which shows a preferred embodiment of the radio segment of the radio module FMM for improving the reception of broadcast radio signals In this case the radio module corresponds in essence to the radio module FMM in FIG. 2, for which reason reference is made to the explanation with respect to FIG. 2 for a detailed explanation of identical components. The components that are known from FIG. 2—such as the antenna ANTM, the antenna switch AS, the receiving device EEM—are rendered only as schematic drawings. The characteristic feature of the embodiment, according to FIG. 7, is that between the antenna switch AS and the power amplifier PA of the transmission device SEM (for reasons relating to a better overview the components that are connected upstream of the power amplifier PA are not illustrated) there is a switch SCH and a filter FI, which is connected downstream of said switch and which exhibits a predetermined frequency pass range, such as a band pass filter BPF, a high pass filter, a low pass filter or a notch filter. As a function of the corresponding switch position of the switch SCH (in the figure when the switch is set downwards) it is possible that the transmission signal generated in the transmission device SEM travels either without any restriction over the first signal path SW1 to the antenna switch AS and from this antenna switch to the antenna ANTM or in a second switch position (in the Figure when the switch is set upwards), as shown in FIG. 7, the transmission signal has to pass the filter FI over a second signal path SW2 in order to finally arrive then over the antenna switch AS at the antenna ANTM.

In order at this point to optimize the transmission device, according to FIG. 7, for the best possible reception of broadcast radio signals, the following steps may be taken. First, the switch SCH is put into a first position, in which the transmission signal, coming from the power amplifier PA, is guided over the first transmission path SW1. Then, as explained with respect to the FIGS. 4 to 6, at times when no broadcast radio signals are received (for example, in the first intermediate time periods) the noise in the receiver chain of the radio module FMD is measured in an advantageous manner, this noise being caused due to a GSM burst, generated by the transmission device SEM. Then, on the one hand, the noise level or also the noise spectrum can be measured. If it turns out that upon simultaneous operation of the transmission device the noise caused by the transmission device interferes too much with the reception of broadcast radio signals—for example, because the noise level is too high—, then this problem can be remedied in that in the event of an activated receiver chain (during a first time period) the switch SCH is moved from the first into the second position, in which the transmission signal is passed through the filter FI, in order to limit the transmission-sided noise, in particular to minimize the noise level in the receiving frequency band of the receiver chain.

In this case it is possible that the measurement and/or detection of the noise caused without the insertion of the filter FI is carried out once or is repeated at defined points in time. If it turns out especially at each measurement of the noise without a filter FI, connected in-between, that the influence of the noise due to the GSM burst on the receiver chain of the radio module FMD is too high, then the transmission device SEM can be home-set in such a manner that when the receiver chain of the radio module FMD and the transmission device SEM of the radio module FMM are operated simultaneously (that is, when the first and the second time periods overlap), the switch SCH is moved into the second position, in order to switch the filter FI into the transmission signal path, whereas when the receiver chain is not activated (in the first intermediate time periods), the switch SCH is moved into the first position.

In summary, it must be stated that individual embodiments shown in the FIGS. 4 to 6 can also be combined with the embodiment shown in FIG. 7 in order to create a communication terminal with radio modules FMD and FMM, which guarantee an optimal reception of broadcast radio signals.

1. Method for operating a communication terminal (MFG), comprising
a receiver chain (EK, EK1, EK2, EK3; LNA, RXD) with at least one receiver component (RXD) and with an amplifier device (LNA), connected upstream of said receiver component, for receiving broadcast radio signals (RFS), which are transmitted in first time periods (ZA1), in a predetermined frequency band (EFB);
a transmission device (SEM) for transmitting radio signals (FST),
wherein the method comprises the following steps:
measuring the noise, occurring upon transmission of the radio signals in the frequency band of the receiver chain, in the receiver chain;
setting the gain (VS) of the amplifier device as a function of the measured noise in such a manner that a maximum signal level, applied to the receiver component, is not exceeded.

2. Method, as claimed in claim 1,
wherein the measurement of the noise in the receiver chain (EK, EK1, EK2, EK3) takes place in first intermediate time periods (ZZA1), which lie between the first time periods (ZA1).

3. Method, as claimed in claim 1 or 2,
wherein the transmission device (SEM) transmits the radio signals (FST) in second time periods (ZA2), which overlap at least partially the first time periods (ZA1).

4. Method, as claimed in any one of the claims 1 to 3,
wherein the measurement of the noise in the receiver chain is carried out repeatedly.

5. Method, as claimed in claim 4,
wherein the measurement of the noise is carried out at regular time intervals.

6. Method, as claimed in any one of the claims 1 to 5,
wherein the transmission device (SEM) is able to vary the transmission frequency, at which it transmits radio signals, the measurement of the noise being then carried out, after the transmission device (SEM) has changed the transmission frequency.

7. Method, as claimed in any one of the claims 1 to 6,
wherein the transmission device (SEM) is able to vary the transmission power, with which it transmits the radio signals, the measurement of the noise being then carried out, after the transmission device has changed the transmission power.

8. Method, as claimed in any one of the claims 4 to 7,
wherein the receiver chain (EK2, EK3) is able to vary the receiving frequency, at which specific broadcast radio signals are received, within the frequency band, the measurement of the noise being then carried out, after the receiver chain has changed the receiving frequency.

9. Method, as claimed in any one of the claims 1 to 8,
wherein prior to conducting the measurement of the noise, the gain (VS) of the amplifier device (LNA) is set to the maximum possible value, at which no destruction of the receiver component (RXD) occurs during the measurement.

10. Method, as claimed in any one of the claims 1 to 9,
wherein, furthermore, the receiver chain exhibits an adjustable band pass filter (BPF) for passing a desired frequency band, the band pass filter being adjusted in such a manner in relation to the frequency band, as a function of the measured noise, that the noise, caused due to the transmission of the radio signals, in the receiver chain is minimized.

11. Method, as claimed in any one of the claims 1 to 10,
wherein, furthermore, the receiver chain (EK3) exhibits a tunable antenna (ANTD) for receiving a desired frequency band, the antenna being adjusted in such a manner in relation to the frequency band as a function of the measured noise that the noise, caused due to the transmission of the radio signals, in the receiver chain is minimized.

12. Method, as claimed in any one of the claims 1 to 11,
wherein during the measurement of the noise the spectral properties of the noise are ascertained, the linearity of the amplifier device (LNA) being set as a function of the determined spectral maxima.

13. Method, as claimed in any one of the claims 1 to 12,
wherein, furthermore, the transmission device (SEM) exhibits an insertable, transmission-sided frequency filter (FI), which is inserted, as a function of the measured noise, into the transmission path of the transmission device, so that the noise, caused due to the transmission of the radio signals (FST), in the receiver chain is minimized.

14. Communication terminal (MFG), in particular, for carrying out a method, as claimed in any one of the preceding claims, with the following features:
a receiver chain (EK, EK1, EK2, EK3; LNA, RXD), comprising at least one receiver component (RXD) and an amplifier device (LNA), which is connected upstream of said receiver component, for receiving broadcast radio signals (RFS), which are transmitted in first time periods (ZA1), in a predetermined frequency band (EFB);
a transmission device (SEM) for transmitting radio signals (FST);
a control unit (STE), which is connected to the receiver chain and is configured so as
to determine the noise, occurring upon transmission of the radio signals (FST) in the frequency band, in the receiver chain, and
to set the gain (VS) of the amplifier device (LNA) as a function of the determined noise in such a manner that a maximum signal level, which is applied to the receiver component, is not exceeded.

15. Communication terminal, as claimed in claim 14,
wherein the control unit (STE) is configured so as to carry out the determination of the noise in the receiver chain in first intermediate time periods (ZZA1), which lie between the first time periods (ZA1).

16. Communication terminal, as claimed in claim 14 or 15,
wherein the transmission device (SEM) transmits the radio signals (FST) in second time periods, which overlap at least partially the first time periods.

17. Communication terminal, as claimed in any one of the claims 14 to 16,
wherein the control unit (STE) is configured so as to carry out repeatedly the detection of noise in the receiver chain.

18. Communication terminal, as claimed in claim 17,
wherein the control unit (STE) is configured so as to carry out at regular time intervals the detection of noise.

19. Communication terminal, as claimed in any one of the claims 14 to 18,
wherein the transmission device (SEM) is able to vary the transmission frequency, at which it transmits the radio signals, the control unit then carrying out the detection of noise, after the transmission device has changed the transmission power.

20. Communication terminal, as claimed in any one of the claims 14 to 19,
wherein the transmission device (SEM) is able to vary the transmission power, with which it transmits the radio signals, the control unit (STE) then carrying out the detection of noise, after the transmission device has changed the transmission power.

21. Communication terminal, as claimed in any one of the claims 14 to 20,
wherein the receiver chain is able to vary the receiving frequency, at which a specific broadcast radio service is received, within the frequency band, the control unit (STE) then carrying out the detection of the noise, after the receiver chain has changed the receiving frequency.

22. Communication terminal, as claimed in any one of the claims 14 to 21,
wherein prior to carrying out the detection of the noise, the control unit sets the gain (VS) of the amplifier device to the maximum possible value, at which no destruction of the receiver component occurs during the measurement.

23. Communication terminal, as claimed in any one of the claims 14 to 22,
wherein, furthermore, the receiver chain exhibits an adjustable band pass filter (BPF) for passing a desired frequency band, the control unit (STE) setting the band pass filter in such a manner in relation to the frequency band, as a function of the measured noise, that the noise, Caused due to the transmission of the radio signals, in the receiver chain is minimized.

24. Communication terminal, as claimed in any one of the claims 14 to 23,
wherein, furthermore, the receiver chain (EK3) exhibits a tunable antenna (ANTD) for receiving a desired frequency band, the control unit (STE) setting the antenna in such a manner in relation to the frequency band as a function of the measured noise that the noise, caused due to the transmission of the radio signals, in the receiver chain is minimized.

25. Communication terminal, as claimed in any one of the claims 14 to 24,
wherein, furthermore, upon determining the noise the spectral properties of the noise are ascertained, the control unit setting the linearity of the amplifier device as a function of the determined spectral maxima.

26. Communication terminal, as claimed in any one of the claims 14 to 25,
wherein, furthermore, the transmission device (SEM) exhibits an insertable, transmission-sided frequency filter (FI), the control unit (STE) inserting, as a function of the measured noise, the transmission-sided frequency filter into the transmission path of the transmission device, so that the noise, caused due to the transmission of the radio signals (FST), in the receiver chain is minimized.

27. Communication terminal, as claimed in any one of the claims 14 to 26,
which is designed as a portable device.

28. Communication terminal, as claimed in claim 27,
which is designed as a mobile radio device, a mobile telephone (MFG) or a portable computer with a radio module.
